(19) United States
(12) Patent Application Publication
(10) Pub. No.: US 2014/0139951 A1
(43) Pub. Date: May 22, 2014

(54) MAGNETIC RECORDING MEDIUM AND MAGNETIC RECORDING/REPRODUCTION APPARATUS

(71) Applicant: KABUSHIKI KAISHA TOSHIBA, Tokyo (JP)

(72) Inventors: Tomoyuki Maeda, Kawasaki-shi (JP); Yousuke Isowaki, Yokohama-shi (JP); Akira Watanabe, Fuchu-shi (JP); Akihiko Takeo, Kunitachi-shi (JP)

(73) Assignee: KABUSHIKI KAISHA TOSHIBA, Tokyo (JP)

(21) Appl. No.: 14/163,871

(22) Filed: Jan. 24, 2014

Related U.S. Application Data
(63) Continuation of application No. 13/350,652, filed on Jan. 13, 2012.

(30) Foreign Application Priority Data
Apr. 28, 2011 (JP) 2011-102121

(51) Int. Cl. G11B 5/74

(52) U.S. Cl. CPC G11B 5/746
USPC 360/110; 428/828

(57) ABSTRACT

According to one embodiment, a perpendicular magnetic recording medium includes a nonmagnetic interlayer formed on a nonmagnetic substrate, an antiferromagnetic layer having a thickness of 2 to 30 nm, a first nonmagnetic underlayer having a thickness of 0.2 to 5 nm, a first bit patterned ferromagnetic layer, a first bit patterned nonmagnetic layer, and a second bit patterned ferromagnetic layer.

### CROSS-REFERENCE TO RELATED APPLICATIONS

This application is a continuation of U.S. patent application Ser. No. 13/350,652, filed Jan. 13, 2012, which is based upon and claims the benefit of priority from prior Japanese Patent Application No. 2011-102121, filed Apr. 28, 2011, the entire contents of each of which are incorporated herein by reference.

### FIELD

Embodiments described herein relate generally to a perpendicular magnetic recording medium for use in, e.g., a hard disk drive using the magnetic recording technique, and a magnetic recording/reproduction apparatus.

### BACKGROUND

A bit patterned medium (BPM) expected as a technique that increases the recording density and capacity of a magnetic recording/reproduction apparatus requires synchronous recording when writing information, due to the theoretical condition that each physically or magnetically isolated magnetic dot records one-bit information.

Although synchronous recording requires a large recording margin, the margin is limited by factors such as the magnetic field gradient of a head, the variation in dot positions, and the variation in magnetic characteristics of dots.

A recently proposed capped layer BPM is a method of reducing the variation in magnetic characteristics of dots as one factor that limits the recording margin, by magnetically coupling a portion of a recording dot with an adjacent dot, and a plurality of structural forms have been proposed for the method.

In any of the structural forms disclosed so far, however, a perpendicular magnetization component is generated in a trench when the magnetization direction of a dot is the same as that of an adjacent dot. Since this perpendicular magnetization component generated in a trench is a noise component, the S/N ratio may decrease. Also, in a capped layer BPM in which a dot magnetic portion is antiferromagnetically coupled with a cap layer, the magnetization of the dot magnetic portion and that of the cap layer may cancel out each other. This may significantly decrease the signal intensity and decrease the S/N ratio. Furthermore, a perpendicular magnetization component is similarly generated in a trench if the cap layer is made of the same material as that of a perpendicular magnetic film in the dot portion.

As described above, a plurality of structures of the capped layer BPM have been proposed, but all of these structures have the problem that a perpendicular magnetization component is generated in a trench of the cap layer when the magnetization direction is the same as that of an adjacent dot. This is a serious problem because the S/N ratio of a signal may consequently decrease.

Accordingly, demands have arisen for a magnetic recording medium that achieves both the effect of reducing an intrinsic SFD (Switching Field Distribution) caused by the variation in magnetic characteristic unique to each individual dot, and the effect of reducing an extrinsic SFD caused by a dipole magnetic field from an adjacent dot, while suppressing the generation of a perpendicular magnetization component in a trench of the cap layer. It is also necessary to prevent the decrease in signal intensity. The values of the intrinsic SFD and extrinsic SFD can be decreased to 5% to 6% or less.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the section of a perpendicular magnetic recording medium according to the first embodiment;

FIG. 2 is an exemplary view showing the section of a perpendicular magnetic recording medium according to the second embodiment;

FIG. 3 is an exemplary view showing the section of a perpendicular magnetic recording medium according to the third embodiment; and

FIG. 4 is an exemplary view showing an outline of a magnetic recording/reproduction apparatus according to the fourth embodiment.

### DETAILED DESCRIPTION

Various embodiments will be described hereinafter with reference to the accompanying drawings.

In general, according to one embodiment, a perpendicular magnetic recording medium according to the first embodiment includes a nonmagnetic substrate, a nonmagnetic interlayer formed on the nonmagnetic substrate, an antiferromagnetic layer formed on the nonmagnetic interlayer and having a thickness of 2 (inclusive) to 30 (inclusive) nm, a first nonmagnetic underlayer formed on the antiferromagnetic layer and having a thickness of 0.2 (inclusive) to 5 (inclusive) nm, and at least three bit-patterned layers formed on the first nonmagnetic underlayer. The bit-patterned layers include a stack of a first bit-patterned ferromagnetic layer, first bit-patterned nonmagnetic layer, and second bit-patterned ferromagnetic layer.

A perpendicular magnetic recording medium according to the second embodiment is a modification of the perpendicular magnetic recording medium according to the above-mentioned first embodiment, and has the same arrangement as that of the first embodiment except that the antiferromagnetic layer is a multilayered structure formed by alternately stacking two or more ferromagnetic layers each having a thickness of 0.2 (inclusive) to 3 (inclusive) nm, and nonmagnetic layers each having a thickness of 0.2 (inclusive) to 3 (inclusive) nm, or a multilayered structure formed by stacking two or more ferromagnetic layers each having a thickness of 0.2 (inclusive) to 3 (inclusive) nm, nonmagnetic layers each having a thickness of 0.2 (inclusive) to 3 (inclusive) nm, and oxide layers each having a thickness of 0.2 (inclusive) to 3 (inclusive) nm.

A perpendicular magnetic recording medium according to the third embodiment has the same arrangement as that of the perpendicular magnetic recording medium according to the first embodiment except that a ferromagnetic layer having a thickness of 1 (inclusive) to 5 (inclusive) nm and made of at least one metal selected from iron, cobalt, and nickel and a ferromagnetic alloy containing the metal and a nonmagnetic metal element is formed instead of the antiferromagnetic layer. Letting X be the maximum composition ratio of an element A as one of Fe, Co, and Ni at which the Curie temperature is 400 K or less in an alloy system between the elements forming the ferromagnetic alloy, a composition ratio Y of the element A in the ferromagnetic alloy is X−20≦Y≦X (at %).

A magnetic recording/reproduction apparatus according to the fourth embodiment includes one of the perpendicular magnetic recording media according to the above-mentioned first, second, and third embodiments, and a recording/reproduction head.

The embodiments can suppress the generation of a perpendicular magnetization component in a trench of the cap layer when the magnetization direction is the same as that of an adjacent dot, while reducing the magnetic characteristic variations (intrinsic SFD and extrinsic SFD) of dots of a bit pattern. It is also possible to suppress the decrease in signal intensity because the magnetization of a dot magnetic portion and that of the cap layer do not cancel out each other. Thus, good magnetic characteristics can be obtained by the embodiments.

The embodiments will be explained below with reference to the accompanying drawings.

### First Embodiment

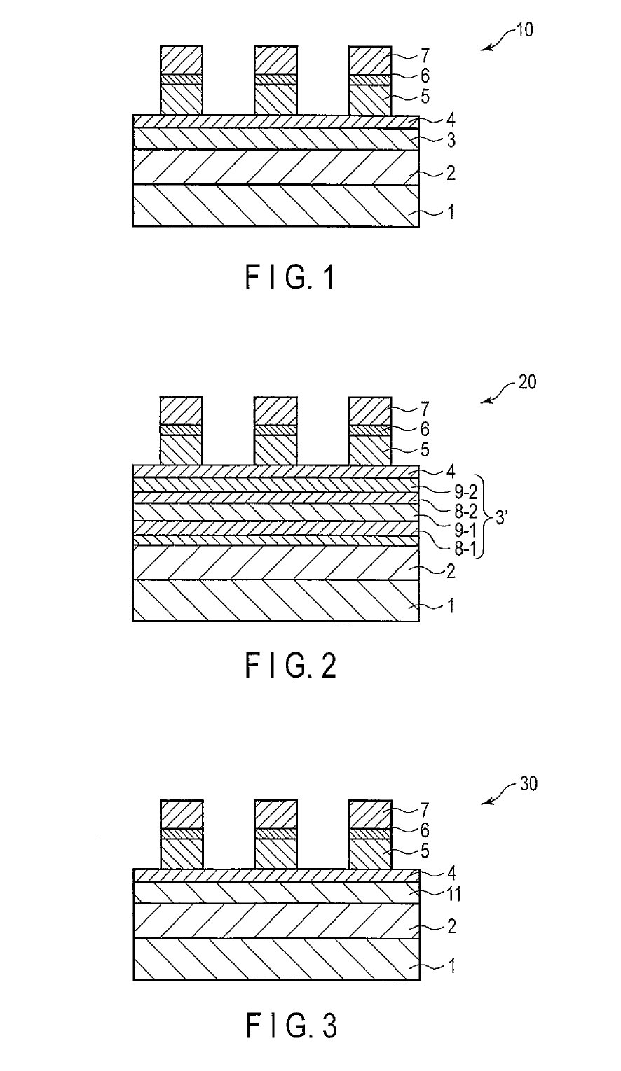

As shown in FIG. 1, the perpendicular magnetic recording medium according to the first embodiment is a perpendicular magnetic recording patterned medium in which a nonmagnetic interlayer 2 is formed on a nonmagnetic substrate 1, an antiferromagnetic layer 3 having a film thickness of 2 (inclusive) to 30 (inclusive) nm is formed on the nonmagnetic interlayer 2, a nonmagnetic layer 4 having a film thickness of 0.2 (inclusive) to 5 (inclusive) nm is formed on the antiferromagnetic layer 3, a ferromagnetic layer 5 is formed on the nonmagnetic layer 4, a nonmagnetic layer 6 is formed on the ferromagnetic layer 5, a ferromagnetic layer 7 is formed on the nonmagnetic layer 6, and at least the ferromagnetic layer 5, nonmagnetic layer 6, and ferromagnetic layer 7 are patterned into a bit pattern shape including a plurality of projections arranged into a predetermined pattern.

The film thickness of the antiferromagnetic layer 3 is 2 (inclusive) to 30 (inclusive) nm. When this film thickness falls within the range of 2 (inclusive) to 30 (inclusive) nm, it is possible to obtain an exchange equivalent field intensity equal to a dipole field intensity. If the film thickness is smaller than 2 nm, it becomes difficult to keep an antiferromagnetic material Neel temperature equal to or higher than room temperature (300K). If the film thickness is larger than 30 nm, the exchange equivalent field intensity becomes higher than the dipole field intensity, and a cluster is formed when dot magnetization reversal occurs. If a cluster is formed, the one bit-one dot characteristic cannot be secured.

As the antiferromagnetic layer 3, it is possible to use any of CrMn, CrRu, CrRh, CrAl, CrCu, FeMn, MnCo, MnPd, MnPt, MnNi, MnIr, and NiO. The composition ratio of any of these alloys is not particularly limited.

Note that when the composition ratio of a combination of two or more elements, e.g., an alloy, is not particularly specified, the composition ratio of the alloy is not particularly limited. For example, CrMn does not mean a Cr composition ratio of 50 at %, but means an alloy of Cr and Mn. Also, it is possible by using any of these materials to obtain an exchange equivalent field intensity that can cancel out the dipole magnetic field at room temperature. Note that each of these antiferromagnetic layer materials can be either an ordered alloy or random alloy, and is not particularly limited. Note also that the easy axis of magnetization of the antiferromagnetic layer can be either the perpendicular direction or in-plane direction.

Since the net magnetization amount is zero in the antiferromagnetic layer, the cap layer in a trench has no perpendicular magnetization component regardless of the state of an adjacent dot.

The film thickness of the nonmagnetic layer 4 can be 0.2 (inclusive) to 5 (inclusive) nm. When this film thickness falls within the range of 0.2 (inclusive) to 5 (inclusive) nm, it is possible to prevent etching damage to the antiferromagnetic layer and corrosion from the underlayers such as the nonmagnetic interlayer and antiferromagnetic layer, while maintaining the crystal orientation of the ferromagnetic layer 5. If the film thickness is smaller than 0.2 nm, layer formation becomes difficult because this film thickness is approximately equal to or smaller than a monoatomic layer. This often reduces the effect of preventing etching damage to the antiferromagnetic layer, and the effect of preventing corrosion from the underlayers. If the film thickness is larger than 5 nm, the crystal orientation of the ferromagnetic layer 5 deteriorates. In this case, the effect of reducing the intrinsic SFD value cannot be obtained.

Examples of the material of the nonmagnetic layer 4 are Pd, Pt, Ru, Cu, Ti, and an alloy containing any of these elements. Since these materials hardly oxidize compared to the underlying antiferromagnetic layer, it is possible to obtain the effect of preventing etching damage to the antiferromagnetic layer, and the effect of preventing corrosion from the underlayers including the antiferromagnetic layer. Note that the nonmagnetic layer 4 can also be omitted if etching damage to the antiferromagnetic layer and corrosion from the underlayers are negligibly small.

The film thickness of the ferromagnetic layer 5 can be 1 (inclusive) to 10 (inclusive) nm. When this film thickness falls within the range of 1 (inclusive) to 10 (inclusive) nm, the thermal stability of a dot can sufficiently be secured. As the material of the ferromagnetic layer 5, a magnetic material by which a high magnetocrystalline anisotropy is obtained can be used. Examples are CoPt, CoCrPt, and CoRuPt as random-phase alloys having a Pt composition ratio of about 10 to 30 at %, and Co/Pt and Co/Pd artificial lattice films and Fe- and Co-based, ordered-phase alloys (e.g., L10FePt, L10FePd, L10CoPt, L11CoPt, L10CoPd, L11CoPd, Co₃Pt, and CoPt₃).

The material of the nonmagnetic interlayer 2 is appropriately selected in accordance with the crystal orientation of the antiferromagnetic layer 3, nonmagnetic layer 4, ferromagnetic layer 5, nonmagnetic layer 6, and ferromagnetic layer 7, particularly, that of the antiferromagnetic layer 3. For example, when the antiferromagnetic layer 3 is MnPt, Pd/Ru can be used as the nonmagnetic interlayer 2. Note that the nonmagnetic interlayer 2 need not be a single layer and may have a multilayered structure including a plurality of layers like Pd/Ru. The film thickness of the nonmagnetic interlayer 2 can be 1 (inclusive) to 200 (inclusive) nm. When the film thickness falls within this range, it is possible to maintain a good crystal orientation (a crystal orientation dispersion of 5 deg or less) of the antiferromagnetic layer 3, nonmagnetic layer 4, ferromagnetic layer 5, nonmagnetic layer 6, and ferromagnetic layer 7, particularly, that of the antiferromagnetic layer 3, and maintain a low surface roughness (Ra of 0.3 nm or less) in the interface of the antiferromagnetic layer 3. If it is impossible to maintain a good crystal orientation (a crystal orientation dispersion of 5 deg or less) and a low surface roughness (Ra of 0.3 nm or less) in the interface of the antiferromagnetic layer 3, it is impossible to reduce the variation in magnetic characteristics of dots, particularly, the intrinsic SFD. In addition, the characteristics as the antiferromagnetic layer 3 weaken, and a perpendicular magnetization component is generated in the cap layer in a trench when the magnetization direction is the same as that of an adjacent dot.

The film thickness of each of the nonmagnetic layer 6 and ferromagnetic layer 7 can be 0.5 (inclusive) to 5 (inclusive) nm. As the material of the nonmagnetic layer 6, it is possible to use, e.g., Pd, Pt, Ru, Cu, Ti, or an alloy containing any of these elements. As the material of the ferromagnetic layer 7, it is possible to use, e.g., Co, CoCr, CoPt, CoPd, Fe, FeCo, FePt, FePd, a [Co/Pt] or [Co/Pd] artificial lattice film, or a multilayered film. Under the conditions, it is possible to reduce the variation in magnetic characteristics of dots, particularly, the intrinsic SFD.

Patterning is performed on at least the ferromagnetic layer 5, nonmagnetic layer 6, and ferromagnetic layer 7. It is also possible to pattern only the ferromagnetic layer 5, nonmagnetic layer 6, and ferromagnetic layer 7, or pattern the ferromagnetic layer 7, the nonmagnetic layer 6, the ferromagnetic layer 5, and a portion of the nonmagnetic layer 4. This makes it possible to suppress the generation of a perpendicular magnetization component in a trench of the cap layer when the magnetization direction is the same as that of an adjacent dot, while reducing the variation in magnetic characteristics of dots.

A portion of the nonmagnetic layer 4 more specifically means a portion of 0.2 (inclusive) to 4.8 (inclusive) nm in the film thickness direction, but the film thickness of an unetched remaining nonmagnetic layer 4 must be 0.2 nm or more. That is, if the film thickness of the nonmagnetic layer 4 is smaller than 0.2 nm, it is possible to pattern only the ferromagnetic layer 7, nonmagnetic layer 6, and ferromagnetic layer 5 without etching the nonmagnetic layer 4.

Furthermore, patterning means not only a physical three-dimensional shape but also a magnetic pattern. That is, patterning includes forming a magnetic pattern by deactivating, by ion implantation or the like, the magnetism of a specific region determined by design or the like, thereby manufacturing a patterned medium. In this case, “a portion of the nonmagnetic layer 4 is patterned” means that the magnetism of a portion of the nonmagnetic layer 4 in the film thickness direction is deactivated.

When forming a physical three-dimensional shape by patterning, the height of the three-dimensional shape can be 15 nm or less, and can also be 1 (inclusive) to 15 (inclusive) nm. Within this range, the floating stability of a head can be assured when the magnetic recording medium according to the embodiment is incorporated into a hard disk drive.

As described above, the perpendicular magnetic recording medium according to the first embodiment uses an antiferromagnetic layer having a net magnetization amount of zero as the cap layer, and hence has the feature that the cap layer in a trench has no perpendicular magnetization component when the magnetization direction is the same as that of an adjacent dot. Note that the signal intensity from a dot and the presence/absence of a perpendicular magnetization component in the cap layer in a trench when the magnetization direction is the same as that of an adjacent dot can be determined by, e.g., acquiring a waveform by using a magnetic head of an HDD or spinstand, or performing MFM (Magnetic Force Microscopy) measurement.

### Second Embodiment

As shown in FIG. 2, the perpendicular magnetic recording medium according to the second embodiment is a perpendicular magnetic recording patterned medium as follows. That is, a nonmagnetic interlayer 2 is formed on a nonmagnetic substrate 1, and an antiferromagnetic layer 3′ is formed on the nonmagnetic interlayer 2. The antiferromagnetic layer 3′ has a multilayered structure formed by alternately stacking two or more ferromagnetic layers and nonmagnetic layers each having a film thickness of 0.2 (inclusive) to 3 (inclusive) nm, or a structure formed by sequentially stacking two or more ferromagnetic layers, nonmagnetic layers, and oxide layers each having a film thickness of 0.2 (inclusive) to 3 (inclusive) nm. In an example shown in FIG. 2, ferromagnetic layers and nonmagnetic layers are alternately stacked twice, thereby forming an antiferromagnetic layer 3′ including a ferromagnetic layer 8-1, nonmagnetic layer 9-1, ferromagnetic layer 8-2, and nonmagnetic layer 9-2. A nonmagnetic layer 4 having a film thickness of 0.2 (inclusive) to 5 (inclusive) nm is formed on the antiferromagnetic layer 3′. A ferromagnetic layer 5 is formed on the nonmagnetic layer 4, a nonmagnetic layer 6 is formed on the ferromagnetic layer 5, a ferromagnetic layer 7 is formed on the nonmagnetic layer 6, and at least the ferromagnetic layer 5, nonmagnetic layer 6, and ferromagnetic layer 7 are processed into a bit pattern shape.

When stacking ferromagnetic layers, nonmagnetic layers, and oxide layers as the antiferromagnetic layer 3′, the film thickness of each layer can be 0.2 (inclusive) to 3 (inclusive) nm. When the film thickness falls within this range, the antiferromagnetic layer 3′ exhibits the antiferromagnetic characteristic even at room temperature or higher. If the film thickness of the ferromagnetic layer is smaller than 0.2 nm, layer formation becomes difficult because this film thickness is approximately equal to or smaller than a monoatomic layer. In this case, no extrinsic SFD value reducing effect can be obtained. If the film thickness of the ferromagnetic layer is larger than 3 nm, the influence of the characteristic as a ferromagnetic layer increases, and the antiferromagnetic characteristic of the multilayered structure as a whole weakens. No extrinsic SFD value reducing effect can be obtained in this case as well.

The film thickness of the nonmagnetic layer in the antiferromagnetic layer 3′ can fall within a film thickness range within which the magnetization components in the upper and lower ferromagnetic layers sandwiching the nonmagnetic layer antiferromagnetically couple with each other. However, if the film thickness of the nonmagnetic layer is smaller than 0.2 nm, layer formation becomes difficult because this film thickness is approximately equal to or smaller than a monoatomic layer, so no antiferromagnetic characteristic can be obtained. In this case, no extrinsic SFD value reducing effect can be obtained. If the film thickness of the nonmagnetic layer is larger than 3 nm, the influence of the characteristic as a nonmagnetic layer increases, and the antiferromagnetic characteristic of the multilayered structure as a whole weakens. No extrinsic SFD value reducing effect can be obtained in this case as well.

If the film thickness of the oxide layer is smaller than 0.2 nm, layer formation becomes difficult because this film thickness is approximately equal to or smaller than a monoatomic layer, so no antiferromagnetic characteristic can be obtained. In this case, no extrinsic SFD value reducing effect can be obtained. If the film thickness of the oxide layer is larger than 3 nm, the influence of the characteristic as an oxide layer increases, and the antiferromagnetic characteristic of the multilayered structure as a whole weakens. No extrinsic SFD value reducing effect can be obtained in this case as well.

In the antiferromagnetic layer 3′, the stacking start layer, the stacking end layer, the stacking order, and the number of times of stacking of the stack including the ferromagnetic layers and nonmagnetic layers or the stack including the ferromagnetic layers, nonmagnetic layers, and oxide layers are not particularly limited, provided that the whole multilayered structure is antiferromagnetic. Note that the easy axis of magnetization of the antiferromagnetic layer 3′ can be either the perpendicular direction or in-plane direction.

Since the net magnetization amount is zero as a whole in the antiferromagnetic layer 3′ having the multilayered structure as described above, the cap layer in a trench has no perpendicular magnetization component regardless of the state of an adjacent dot.

As the material of the ferromagnetic layer in the antiferromagnetic layer 3′, Fe, Co, Ni, FeCo, CoCr, or CoRu can be used. As the material of the nonmagnetic layer, Cr, Ru, Cu, Au, or Ag can be used. As the material of the oxide layer, an oxide of the ferromagnetic layer or SiO₂ can be used. An antiferromagnetic layer having a multilayered structure in which combinations of these materials are stacked a plurality of number of times, i.e., two or more can suppress the generation of a perpendicular magnetization component in a trench of the cap layer when the magnetization direction is the same as that of an adjacent dot, while reducing the variation in magnetic characteristics of dots.

The film thickness of the nonmagnetic layer 4 formed on the antiferromagnetic layer 3′ can be 0.2 (inclusive) to 5 (inclusive) nm. When this film thickness falls within the range of 0.2 (inclusive) to 5 (inclusive) nm, it is possible to prevent etching damage to the antiferromagnetic layer 3′ and corrosion from the underlayers, while maintaining the crystal orientation of the ferromagnetic layer 5. If the film thickness is smaller than 0.2 nm, layer formation becomes difficult because this film thickness is approximately equal to or smaller than a monoatomic layer. This often deteriorates the effect of preventing etching damage to the antiferromagnetic layer 3′, and the effect of preventing corrosion from the underlayers. If the film thickness is larger than 5 nm, the crystal orientation of the ferromagnetic layer 5 tends to deteriorate.

As the material of the nonmagnetic layer 4, it is possible to use, e.g., Pd, Pt, Ru, Cu, Ti, or an alloy containing any of these elements. Since these materials hardly oxidize compared to the underlying antiferromagnetic layer 3′, it is possible to obtain the effect of preventing etching damage to the antiferromagnetic layer 3′, and the effect of preventing corrosion from the underlayers including the antiferromagnetic layer 3′. Note that the nonmagnetic layer 4 can also be omitted if etching damage to the antiferromagnetic layer 3′ and corrosion from the underlayers are negligibly small.

The film thickness of the ferromagnetic layer 5 can be 1 (inclusive) to 10 (inclusive) nm. When this film thickness falls within the range of 1 (inclusive) to 10 (inclusive) nm, the thermal stability of a dot can sufficiently be ensured. As the material of the ferromagnetic layer 5, a magnetic material by which a high magnetocrystalline anisotropy is obtained can be used. Examples are CoPt, CoCrPt, and CoRuPt as random-phase alloys having a Pt composition ratio of about 10 to 30 at %, and Co/Pt and Co/Pd artificial lattice films and Fe- and Co-based, ordered-phase alloys (e.g., L10FePt, L10FePd, L10CoPt, L11CoPt, L10CoPd, L11CoPd, Co₃Pt, and CoPt₃).

The material of the nonmagnetic interlayer 2 is appropriately selected in accordance with the crystal orientation of the antiferromagnetic layer 3′, nonmagnetic layer 4, ferromagnetic layer 5, nonmagnetic layer 6, and ferromagnetic layer 7, particularly, that of the antiferromagnetic layer 3′. For example, when the antiferromagnetic layer 3′ is a [Co/Cr] multilayered film, Pd/Ru is used as the nonmagnetic interlayer 2. Note that the nonmagnetic interlayer 2 need not be a single layer and may have a multilayered structure including a plurality of layers like Pd/Ru. The film thickness of the nonmagnetic interlayer 2 can be 1 (inclusive) to 200 (inclusive) nm. When the film thickness falls within this range, it is possible to maintain a good crystal orientation (a crystal orientation dispersion of 5 deg or less) of the antiferromagnetic layer 3′, nonmagnetic layer 4, ferromagnetic layer 5, nonmagnetic layer 6, and ferromagnetic layer 7, particularly, that of the antiferromagnetic layer 3′, and maintain a low surface roughness (Ra of 0.3 nm or less) in the interface of the antiferromagnetic layer 3′. If it is impossible to maintain a good crystal orientation (a crystal orientation dispersion of 5 deg or less) and a low surface roughness (Ra of 0.3 nm or less) in the interface of the antiferromagnetic layer 3′, it is impossible to reduce the variation in magnetic characteristics of dots, particularly, the intrinsic SFD. In addition, the characteristics as an antiferromagnetic layer weaken, and a perpendicular magnetization component is generated in the cap layer in a trench when the magnetization direction is the same as that of an adjacent dot.

The film thickness of each of the nonmagnetic layer 6 and ferromagnetic layer 7 can be 0.5 (inclusive) to 5 (inclusive) nm. As the material of the nonmagnetic layer 6, it is possible to use, e.g., Pd, Pt, Ru, Cu, Ti, or an alloy containing any of these elements. As the material of the ferromagnetic layer 7, it is possible to use, e.g., Co, CoCr, CoPt, CoPd, Fe, FeCo, FePt, FePd, or a [Co/Pt] or [Co/Pd] artificial lattice film or multilayered film. Under the conditions, it is possible to reduce the variation in magnetic characteristics of dots, particularly, the intrinsic SFD.

Patterning is performed on at least the ferromagnetic layer 7, nonmagnetic layer 6, and ferromagnetic layer 5. It is also possible to pattern only the ferromagnetic layer 7, nonmagnetic layer 6, and ferromagnetic layer 5, or pattern the ferromagnetic layer 7, the nonmagnetic layer 6, the ferromagnetic layer 5, and a portion of the nonmagnetic layer 4. This makes it possible to suppress the generation of a perpendicular magnetization component in a trench of the cap layer when the magnetization direction is the same as that of an adjacent dot, while reducing the variation in magnetic characteristics of dots of a bit pattern.

A portion of the nonmagnetic layer 4 more specifically means a portion of 0.2 (inclusive) to 4.8 (inclusive) nm in the film thickness direction, but the film thickness of an unetched remaining nonmagnetic layer 4 must be 0.2 nm or more. That is, if the film thickness of the nonmagnetic layer 4 is smaller than 0.2 nm, it is possible to pattern only the ferromagnetic layer 7, nonmagnetic layer 6, and ferromagnetic layer 5 without etching the nonmagnetic layer 4.

Furthermore, patterning means not only a physical three-dimensional shape but also a magnetic pattern. That is, patterning includes forming a magnetic pattern by deactivating, by ion implantation or the like, the magnetism of a specific region determined by design or the like, thereby manufacturing a patterned medium. In this case, “a portion of the nonmagnetic layer 4 is patterned” means that the magnetism of a portion of the nonmagnetic layer 4 in the film thickness direction is deactivated.

When forming a physical three-dimensional shape by patterning, the height of the three-dimensional shape can be 15 nm or less, and can also be 1 (inclusive) to 15 (inclusive) nm. Within this range, the floating stability of a head can be assured when the magnetic recording medium according to the embodiment is incorporated into a hard disk drive.

As described above, the second embodiment uses an antiferromagnetic layer having a net magnetization amount of zero as the cap layer, and hence has the feature that the cap layer in a trench has no perpendicular magnetization component when the magnetization direction is the same as that of an adjacent dot. Note that the signal intensity from a dot and the presence/absence of a perpendicular magnetization component in the cap layer in a trench when the magnetization direction is the same as that of an adjacent dot can be determined by, e.g., acquiring of a waveform by using a magnetic head of an HDD or spinstand, or performing MFM measurement.

### Third Embodiment

As shown in FIG. 3, the third embodiment is a perpendicular magnetic recording patterned medium as follows. That is, a nonmagnetic interlayer 2 is formed on a nonmagnetic substrate 1, and a ferromagnetic layer 11 having a film thickness of 1 (inclusive) to 5 (inclusive) nm and made of a ferromagnetic alloy containing one or any combination of Fe, Co, and Ni and a nonmagnetic element is formed on the nonmagnetic interlayer 2. Letting X be the maximum composition ratio of an element A as one of Fe, Co, and Ni at which the Curie temperature is 400 K or less in an alloy system between the elements forming the ferromagnetic alloy, a composition ratio Y of the element A in the ferromagnetic alloy is X−20≦Y≦X (at %). In addition, a nonmagnetic layer 4 having a film thickness of 0.2 (inclusive) to 5 (inclusive) nm is formed on the ferromagnetic layer 11, a ferromagnetic layer 5 is formed on the nonmagnetic layer 4, a nonmagnetic layer 6 is formed on the ferromagnetic layer 5, a ferromagnetic layer 7 is formed on the nonmagnetic layer 6, and at least the ferromagnetic layer 5, nonmagnetic layer 6, and ferromagnetic layer 7 are patterned.

As the ferromagnetic layer 11, it is possible to select a material that is ferromagnetic and has a very low film exchange coupling intensity. When the film exchange coupling is very weak, the magnetocrystalline anisotropy perpendicular to the film surface is also very low. This makes it possible to prevent the generation of a perpendicular magnetization component in a trench of the cap layer when the magnetization direction is the same as that of an adjacent dot.

A ferromagnetic material having a very weak exchange coupling can be implemented near room temperature (250 to 350 K) by decreasing the Curie temperature of an alloy system containing one or any combination of Fe, Co, and Ni and a nonmagnetic element, by reducing the composition ratio of Fe, Co, or Ni contained in the alloy. Letting X be the maximum composition ratio, at which the Curie temperature is 400 K or less, of the element A as one of Fe, Co, and Ni when the composition ratio of Fe, Co, or Ni is a parameter, the composition ratio Y of the element A in a magnetic layer capable of achieving the effect of this embodiment can be obtained within the range of X−20≦Y≦X (at %).

Accordingly, the ferromagnetic layer 11 is made of a ferromagnetic alloy containing one or any combination of Fe, Co, and Ni and a nonmagnetic element, in which letting X be the maximum composition ratio of the element A as one of Fe, Co, and Ni at which the Curie temperature is 400 K or less in an alloy system between the elements forming the ferromagnetic alloy, the composition ratio Y of the element A is X−20≦Y≦X (at %).

Whether a cap magnetic layer of interest satisfies the conditions as the cap layer magnetic film of this embodiment can be determined by, e.g., performing local EDX (Energy Dispersive X-ray spectrometry) analysis and checking the Curie temperature characteristic of the alloy system between the elements.

More specifically, elements forming a cap magnetic layer of interest, an alloy system containing the elements, and the composition ratios of the elements can be determined by local EDX analysis. The dependence of the Curie temperature on the composition ratio of one of Fe, Co, and Ni in the determined alloy system can be obtained by separately forming the alloy system and conducting an experiment. This makes it possible to obtain the maximum composition ratio X of one of Fe, Co, and Ni at which the Curie temperature is 400 K or less in the alloy system. As a consequence, whether the cap magnetic layer of interest is the embodiment can be determined.

The material of the ferromagnetic layer 11 is not particularly limited as long as the material meets the above-mentioned condition concerning the composition ratio, which affects the exchange coupling intensity of a magnetic film, of Fe, Co, or Ni contained in the magnetic layer. That is, it is possible to use any of CoCr, CoCrPt, CoPt, CoPd, CoRu, CoCu, FeCr, FeCrPt, FePt, FePd, FeRu, FeCu, NiCr, NiCrPt, NiPt, NiPd, NiRu, and NiCu. These materials are presumably favorable from the viewpoint of the crystal orientation of the ferromagnetic layer 5. It is possible to use any of (60 (inclusive) to 80 (inclusive) at %)Co—Cr, (60 (inclusive) to 80 (inclusive) at %)Co-(10 (inclusive) to 30 (inclusive) at %)Cr—Pt, (10 (inclusive) to 30 (inclusive) at %)Co—Pt, (10 (inclusive) to 30 (inclusive) at %)Co—Pd, (15 (inclusive) to 35 (inclusive) at %)Co—Ru, (30 (inclusive) to 50 (inclusive) at %)Co—Cu, (60 (inclusive) to 80 (inclusive) at %)Fe—Cr, (60 (inclusive) to 80 (inclusive) at %)Fe-(10 (inclusive) to 30 (inclusive) at %)Cr—Pt, (10 (inclusive) to 30 (inclusive) at %)Fe—Pt, (10 (inclusive) to 30 (inclusive) at %)Fe—Pd, (15 (inclusive) to 35 (inclusive) at %)Fe—Ru, (30 (inclusive) to 50 (inclusive) at %)Fe—Cu, (30 (inclusive) to 50 (inclusive) at %)Ni—Cr, (30 (inclusive) to 50 (inclusive) at %)Ni-(50 (inclusive) to 70 (inclusive) at %)Cr—Pt, (40 (inclusive) to 60 (inclusive) at %)Ni—Pt, (40 (inclusive) to 60 (inclusive) at %)Ni—Pd, (40 (inclusive) to 60 (inclusive) at %)Ni—Ru, and (30 (inclusive) to 50 (inclusive) at %)Ni—Cu.

The film thickness of the ferromagnetic layer 11 can be 1 (inclusive) to 5 (inclusive) nm. When this film thickness falls within the range of 1 (inclusive) to 5 (inclusive) nm, it is possible to adjust the exchange equivalent field intensity corresponding to the exchange coupling intensity, while assuring the flatness of the film. If the film thickness falls outside this range, it is impossible to secure the flatness of the film, particularly, a good crystal orientation of the ferromagnetic layer 5. Consequently, no intrinsic SFD reducing effect can be obtained.

The film thickness of the ferromagnetic layer 5 can be 1 (inclusive) to 10 (inclusive) nm. When this film thickness falls within the range of 1 (inclusive) to 10 (inclusive) nm, the thermal stability of a dot can sufficiently be ensured. As the material of the ferromagnetic layer 5, a magnetic material by which a high magnetocrystalline anisotropy is obtained can be used. Examples are CoPt, CoCrPt, and CoRuPt as random-phase alloys having a Pt composition ratio of about 10 to 30 at %, and Co/Pt and Co/Pd artificial lattice films and Fe- and Co-based, ordered-phase alloys (e.g., L10FePt, L10FePd, L10CoPt, L11CoPt, L10CoPd, L11CoPd, Co₃Pt, and CoPt₃).

The material of the nonmagnetic interlayer 2 is appropriately selected in accordance with the crystal orientation of the ferromagnetic layer 11, nonmagnetic layer 4, ferromagnetic layer 5, nonmagnetic layer 6, and ferromagnetic layer 7, particularly, that of the ferromagnetic layer 11. For example, when the ferromagnetic layer 11 is Co-80 at % Ru, Pd/Ru is used as the nonmagnetic interlayer 2. Note that the nonmagnetic interlayer 2 need not be a single layer and may have a multilayered structure including a plurality of layers like Pd/Ru. The film thickness of the nonmagnetic interlayer 2 can be 1 (inclusive) to 200 (inclusive) nm. When the film thickness falls within this range, it is possible to maintain a good crystal orientation (a crystal orientation dispersion of 5 deg or less) of the ferromagnetic layer 11, nonmagnetic layer 4, ferromagnetic layer 5, nonmagnetic layer 6, and ferromagnetic layer 7, particularly, that of the ferromagnetic layer 11, and maintain a low surface roughness (Ra of 0.3 nm or less) in the interface of the ferromagnetic layer 11. If it is impossible to maintain a good crystal orientation (a crystal orientation dispersion of 5 deg or less) and a low surface roughness (Ra of 0.3 nm or less) in the interface of the ferromagnetic layer 11, it is impossible to reduce the variation in magnetic characteristics of dots, particularly, the intrinsic SFD. In addition, the characteristics as the ferromagnetic layer 11 weaken, and a perpendicular magnetization component is generated in the cap layer in a trench when the magnetization direction is the same as that of an adjacent dot.

The film thickness of each of the nonmagnetic layer 6 and ferromagnetic layer 7 can be 0.5 (inclusive) to 5 (inclusive) nm. As the material of the nonmagnetic layer 6, it is possible to use, e.g., Pd, Pt, Ru, Cu, Ti, or an alloy containing any of these elements. Examples of the material of the ferromagnetic layer 7 are Co, CoCr, CoPt, CoPd, Fe, FeCo, FePt, FePd, and [Co/Pt] and [Co/Pd] artificial lattice films and multilayered films. Under the conditions described above, it is possible to reduce the variation in magnetic characteristics of dots, particularly, the intrinsic SFD.

Patterning can be performed on at least the ferromagnetic layer 7, nonmagnetic layer 6, and ferromagnetic layer 5. It is also possible to pattern only the ferromagnetic layer 7, nonmagnetic layer 6, and ferromagnetic layer 5, or pattern the ferromagnetic layer 7, the nonmagnetic layer 6, the ferromagnetic layer 5, and a portion of the nonmagnetic layer 4. This makes it possible to suppress the generation of a perpendicular magnetization component in a trench of the cap layer when the magnetization direction is the same as that of an adjacent dot, while reducing the variation in magnetic characteristics of dots.

A portion of the nonmagnetic layer 4 more specifically means a portion of 0.2 (inclusive) to 4.8 (inclusive) nm in the film thickness direction, but the film thickness of an unetched remaining nonmagnetic layer 4 must be 0.2 nm or more. That is, if the film thickness of the nonmagnetic layer 4 is smaller than 0.2 nm, the ferromagnetic layer 7, nonmagnetic layer 6, and ferromagnetic layer 5 are patterned without etching the nonmagnetic layer 4.

Furthermore, patterning means not only a physical three-dimensional shape but also a magnetic pattern. That is, patterning includes forming a magnetic pattern by deactivating, by ion implantation or the like, the magnetism of a specific region determined by design or the like, thereby manufacturing a patterned medium. In this case, “a portion of the nonmagnetic layer 4 is patterned” means that the magnetism of a portion of the nonmagnetic layer 4 in the film thickness direction is deactivated. When forming a physical three-dimensional shape by patterning, the height of the three-dimensional shape can be 10 nm or less, and can also be 1 (inclusive) to 10 (inclusive) nm. Within this range, the floating stability of a head can be assured when the magnetic recording medium according to this embodiment is incorporated into a hard disk drive.

### Fourth Embodiment

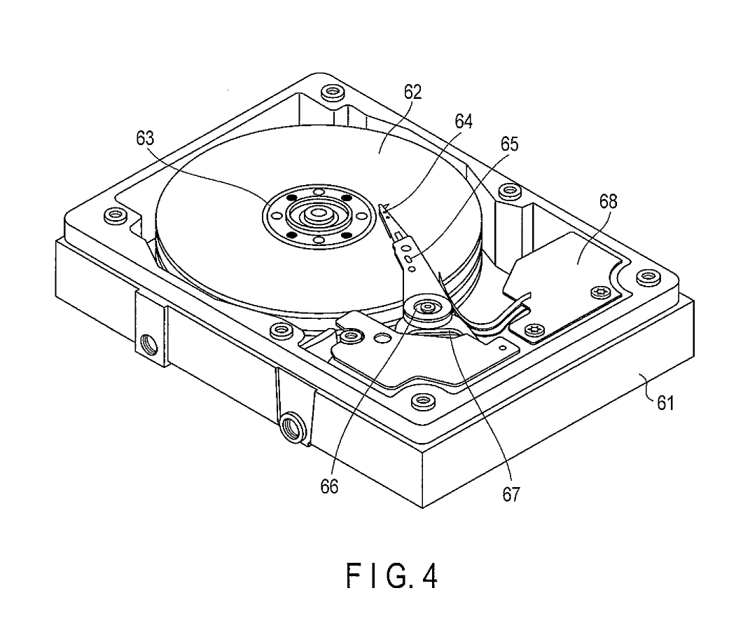

FIG. 4 is a partially exploded perspective view of an example of a magnetic recording/reproduction apparatus according to the embodiment.

The magnetic recording/reproduction apparatus according to the embodiment includes the above-described patterned medium and a recording/reproduction head.

In a magnetic recording/reproduction apparatus 60 according to the embodiment, a rigid magnetic disk 62 for recording information according to the embodiment is mounted on a spindle 63, and rotated at a predetermined rotational speed by a spindle motor (not shown). A slider 64 on which a recording head for recording information by accessing the magnetic disk 62 and an MR head for reproducing information are mounted is fixed to the distal end of a suspension 65 made of a thin leaf spring. The suspension 65 is connected to one end of an arm 66 including a bobbin for holding a driving coil (not shown).

A voice coil motor 67 as a kind of a linear motor is installed at the other end of the arm 66. The voice coil motor 67 includes the driving coil (not shown) wound up on the bobbin of the arm 66, and a magnetic circuit including a permanent magnet and counter yoke facing each other so as to sandwich the driving coil between them.

The arm 66 is held by ball bearings (not shown) formed in two, upper and lower portions of a fixed shaft, and swung by the voice coil motor 67. That is, the voice coil motor 67 controls the position of the slider 64 on the magnetic disk 62. Note that reference numeral 61 in FIG. 4 denotes a housing.

### EXAMPLES

### Example 1

A bit patterned medium according to the first embodiment was manufactured as follows.

Film deposition was performed by the C3010 available from ANELVA by using Ar gas as a sputtering gas at a sputtering pressure of 0.7 Pa. The film configuration included a soft magnetic underlayer (10-nm thick CoZrTa), nonmagnetic interlayer (4-nm thick Pd/10-nm thick Ru), antiferromagnetic layer (5-nm thick MnPt), nonmagnetic layer (1.5-nm thick Pd), ferromagnetic layer (7-nm thick CoPt), nonmagnetic layer (1.0-nm thick Pd), and ferromagnetic layer (3-nm thick Co) from the glass substrate side. A 20-nm thick C layer was deposited as a BPM processing mask material on these films.

BPM patterning was performed by forming a dot-shaped mask by a self-organizing material made of 35-nm pitch polystyrene-polydimethylsiloxane (PS-PDMS), transferring the pattern onto the C mask by using an RIE apparatus, and performing magnetic film etching by Ar milling.

As the etching depth of this magnetic film etching, the end point of etching of the ferromagnetic film (7-nm thick CoPt) was set as a stop point by using an end point monitor based on secondary ion mass spectrometry (SIMS). After this magnetic film etching, the mask was removed by O₂ RIE, and a C protective film about 10 nm thick was deposited, thereby forming a bit patterned medium.

The obtained bit patterned medium had the same arrangement as that shown in FIG. 1 except that the soft magnetic underlayer (not shown) was formed between the nonmagnetic substrate 1 and nonmagnetic interlayer 2, and the protective layer (not shown) was formed on the nonmagnetic layer 4 and on the ferromagnetic layer 5, nonmagnetic layer 6, and ferromagnetic layer 7 formed on the nonmagnetic layer 4 and patterned.

The magnetic characteristics of the obtained bit patterned medium were measured as follows.

As the magnetic characteristic measurements, SFD analysis was first performed by measuring the hysteresis characteristic by using the magnetooptical Kerr effect. Consequently, an intrinsic SFD (σHc/Hc) of 5% and an extrinsic SFD (a contribution to the SFD by the dipole magnetic field) of 1% were obtained.

Note that the intrinsic SFD was calculated by the ΔHc method, and the extrinsic SFD was calculated by using the intrinsic SFD value and a differential curve near the Hc of the hysteresis curve. Also, the medium was DC-magnetized by an external magnetic field, and the residual magnetization configuration was measured by MFM. As a consequence, no signal indicating the existence of a perpendicular magnetization component in a dot trench was obtained. That is, no perpendicular magnetization component existed in a trench of the cap layer. Note that the magnitude of an MFM signal output proportional to the magnetization amount from a dot was 5 mV by reflecting a large magnetization amount.

In addition, bit patterned media were manufactured by using CrMn, CrRu, CrRh, CrAl, CrCu, FeMn, MnPt, MnCo, MnPd, MnNi, MnIr, and NiO as antiferromagnetic layer materials, and SFD analysis and MFM analysis were performed. Consequently, the same results as those of the medium in which the antiferromagnetic layer was 5-nm thick MnPt were obtained.

Table 1 below shows the results.

Note that in the following explanation, ◯ indicates good and X indicates unacceptable as the MFM results in tables.

TABLE 1

| Antiferromagnetic | SFD intrinsic | SFD extrinsic | |
|---|---|---|---|
| material | (%) | (%) | MFM result |
| MnPt | 5.0 | 1.0 | ◯ |
| CrMn | 4.6 | 0.8 | ◯ |
| CrRu | 4.8 | 0.8 | ◯ |
| CrRh | 5.1 | 0.7 | ◯ |
| CrAl | 5.0 | 0.9 | ◯ |
| CrCu | 5.0 | 1.1 | ◯ |
| FeMn | 5.3 | 1.0 | ◯ |
| MnPt | 4.9 | 0.8 | ◯ |
| MnCo | 4.7 | 1.2 | ◯ |
| MnPd | 4.7 | 1.1 | ◯ |
| MnNi | 5.2 | 1.0 | ◯ |
| NiO | 5.1 | 1.2 | ◯ |

### Example 2

A bit patterned medium according to the second embodiment was manufactured following the same procedures as in Example 1 except that the arrangement of the antiferromagnetic layer was changed.

The obtained bit patterned medium had the same arrangement as that shown in FIG. 2 except that a soft magnetic underlayer (not shown) was formed between the nonmagnetic substrate 1 and nonmagnetic interlayer 2.

In Example 2, as the antiferromagnetic layer 3′, an antiferromagnetic layer was deposited by alternately stacking Co (0.4 nm) as ferromagnetic layers and Cr (0.8 nm) as nonmagnetic layers four times. The stack of the antiferromagnetic layer thus obtained is represented by [Co (0.4 nm)/Cr (0.8 nm)] 4. Note that BPM patterning was performed by adjusting, e.g., the etching time in accordance with the arrangement of the antiferromagnetic layer 3′.

When SFD analysis and MFM measurement were performed in the same manner as in Example 1, an intrinsic SFD of 5.2% and an extrinsic SFD of 1.7% were obtained. Also, the result of MFM measurement after DC magnetization was the same as that in Example 1, i.e., no signal indicating the existence of a perpendicular magnetization component in a trench of the cap layer was obtained. Furthermore, the MFM signal output at that time was 5.3 mV.

In addition, bit patterned media were manufactured by using, as antiferromagnetic layers 3′, [Fe/Cr] 4, [Fe/Cu] 4, [Fe/Ru] 4, [Fe/Au] 4, [Fe/Ag] 4, [Co/Cr] 4, [Co/Cu] 4, [Co/Ru] 4, [Co/Au] 4, [Co/Ag] 4, [Fe/Cr/Fe/Fe oxide or SiO₂] 4, [Fe/Cu/Fe/Fe oxide or SiO₂] 4, [Fe/Ru/Fe/Fe oxide or SiO₂] 4, [Fe/Au/Fe/Fe oxide or SiO₂] 4, [Fe/Ag/Fe/Fe oxide or SiO₂] 4, [Co/Cr/Co/Co oxide or SiO₂] 4, [Co/Cu/Co/Co oxide or SiO₂] 4, [Co/Ru/Co/Co oxide or SiO₂] 4, [Co/Au/Co/Co oxide or SiO₂] 4, and [Co/Ag/Co/Co oxide or SiO₂] 4, by combining Fe, Co, Ni, FeCo, CoCr, and CoRu as ferromagnetic layers, Cr, Ru, Cu, Au, and Ag as nonmagnetic layers, SiO₂ and oxides of the ferromagnetic layers as oxide layers. When SFD analysis and MFM analysis were performed, the same results as those of [Co (0.4 nm)/Cr (0.8 nm)] 4 as the antiferromagnetic layer 3′ formed by stacking Co (0.4 nm) as ferromagnetic layers and Cr (0.8 nm) as nonmagnetic layers four times were obtained.

Table 2 shows some of the results.

TABLE 2

| Antiferromagnetic | SFD intrinsic | SFD extrinsic | |
|---|---|---|---|
| layer | (%) | (%) | MFM result |
| (Co/Cr)4 | 5.2 | 1.7 | ◯ |
| (Co/Ru)4 | 4.3 | 1.6 | ◯ |
| (Co/Cu)4 | 4.6 | 1.3 | ◯ |
| (Co/Au)4 | 5.1 | 1.2 | ◯ |
| (Co/Ag)4 | 5.3 | 1.1 | ◯ |
| (Fe/Cr)4 | 5.6 | 1.3 | ◯ |
| (Fe/Ru)4 | 5.7 | 1.2 | ◯ |
| (Fe/Cu)4 | 5.6 | 1.2 | ◯ |
| (Fe/Au)4 | 5.7 | 1.7 | ◯ |
| (Fe/Ag)4 | 5.5 | 1.5 | ◯ |
| (Ni/Cr)4 | 5.1 | 1.8 | ◯ |
| (FeCo/Cr)4 | 5.1 | 1.6 | ◯ |
| (CoCr/Cr)4 | 5.4 | 1.7 | ◯ |
| (CoRu/Cr)4 | 5.5 | 1.4 | ◯ |
| (Co/Cr/Co/CoO)4 | 4.8 | 1.1 | ◯ |
| (Co/Cr/Co/SiO₂)4 | 4.6 | 1.4 | ◯ |

### Example 3

A bit patterned medium according to the third embodiment was manufactured following the same procedures as in Example 1 except that a predetermined ferromagnetic layer was formed instead of the antiferromagnetic layer.

The obtained bit patterned medium had the same arrangement as that shown in FIG. 3 except that a soft magnetic underlayer (not shown) was formed between the nonmagnetic substrate 1 and nonmagnetic interlayer 2.

This medium was manufactured following the same procedures as in Example 1 except that Co-80 at % Ru (3 nm) was deposited as the ferromagnetic layer 11 instead of the antiferromagnetic layer 3 in Example 1.

When SFD analysis and MFM measurement were performed in the same manner as in Example 1, an intrinsic SFD of 5.1% and an extrinsic SFD of 1.3% were obtained. Also, the result of MFM measurement after DC magnetization was the same as that in Example 1, i.e., no signal indicating the existence of a perpendicular magnetization component in a trench of the cap layer was obtained. Furthermore, the MFM signal output at that time was 5.6 mV.

In addition, bit patterned media were manufactured by using, as ferromagnetic layers 11, alloys each containing one of Fe, Co, and Ni, e.g., Co-30 at % Cr (3 nm), 60 at % Co-20 at % Cr—Pt (3 nm), Co-80 at % Pt (3 nm), Co-80 at % Pd (3 nm), Fe-80 at % Pt (3 nm), and Ni-60 at % Pd (3 nm), and SFD analysis and MFM analysis were performed. Consequently, the same results as those of the medium in which the ferromagnetic layer 11 was Co-80 at % Ru (3 nm) were obtained.

Table 3 below shows the results.

TABLE 3

| Material of | | | |
|---|---|---|---|
| ferromagnetic | SFD intrinsic | SFD extrinsic | |
| layer 4 | (%) | (%) | MFM result |
| CoCr | 5.2 | 1.2 | ◯ |
| CoCrPt | 4.8 | 1.1 | ◯ |
| CoPt | 5.1 | 1.1 | ◯ |
| CoPd | 4.5 | 1.0 | ◯ |
| CoRu | 5.1 | 1.3 | ◯ |
| CoCu | 5.6 | 1.5 | ◯ |
| FeCr | 5.5 | 1.6 | ◯ |
| FeCrPt | 5.5 | 1.8 | ◯ |
| FePt | 5.8 | 1.7 | ◯ |
| FePd | 5.8 | 1.6 | ◯ |
| FeRu | 5.7 | 2.0 | ◯ |
| FeCu | 5.6 | 1.9 | ◯ |
| NiCr | 5.1 | 2.1 | ◯ |
| NiCrPt | 5.4 | 2.3 | ◯ |
| NiPt | 5.4 | 2.3 | ◯ |
| NiPd | 5.5 | 2.2 | ◯ |
| NiRu | 5.6 | 2.5 | ◯ |
| NiCu | 5.7 | 1.9 | ◯ |

### Comparative Example 1

As a comparative example, a BPM having a capped layer structure in which Co (2 nm) was used as a soft layer material instead of the antiferromagnetic layer in Example 1, Ru (0.7 nm) was used as a nonmagnetic layer formed on the antiferromagnetic layer, and magnetization in a bit patterned ferromagnetic layer formed on the nonmagnetic layer and magnetization in the Co soft layer as a cap layer were antiferromagnetically coupled with each other was manufactured. The medium manufacturing process was the same as that of Example 1.

When SFD analysis and MFM measurement were performed on the manufactured medium in the same manner as in Example 1, an intrinsic SFD of 5.3% and an extrinsic SFD of 1.4% were obtained. These SFD values were equivalent to those obtained in Examples 1, 2, and 3. In MFM measurement after DC magnetization, however, a magnetization signal was obtained even in a dot trench, and the MFM signal output was 2.1 mV, i.e., about half the signal outputs in Examples 1, 2, and 3, indicating that the S/N ratio of the signal was very low. As a consequence, dot contours in an MFM magnetic image were very unclear compared to those in Examples 1, 2, and 3.

The effects of reducing the intrinsic SFD and extrinsic SFD were obtained by the medium structure of Comparative Example 1. However, the signal intensity from a dot largely reduced because magnetizations in the ferromagnetic layers 5 and 7 and that in the cap layer were antiferromagnetically coupled with each other. Also, a perpendicular magnetization component was generated in a trench of the cap layer when the magnetization direction was the same as that of an adjacent dot.

### Comparative Example 2

As a comparative example, a BPM using a single CoPt (7 nm) ferromagnetic layer as a magnetic recording layer was manufacturing by omitting the antiferromagnetic layer and the nonmagnetic layer, patterned ferromagnetic layer, and patterned nonmagnetic layer formed on the antiferromagnetic layer in Example 1. Although the BPM processing method was generally the same as that of Example 1, the depth of magnetic film etching was set such that the 7 nm thick CoPt magnetic recording layer was entirely etched.

To check the magnetic characteristics after the processing, SFD analysis and MFM measurement were performed in the same manner as in Example 1. Consequently, an intrinsic SFD of 10% and an extrinsic SFD of 15% were obtained.

These SFD values were much larger than those of Examples 1, 2, and 3, demonstrating that the medium structure of Comparative Example 2 was unable to reduce the SFD values. Note that in MFM measurement after DC magnetization, no signal output resulting from a perpendicular magnetization component in a trench of the cap layer was found.

From the results of Examples 1, 2, and 3 and Comparative Examples 1 and 2 described above, each embodiment can achieve both the effect of reducing the intrinsic SFD and the effect of reducing the extrinsic SFD caused by the dipole magnetic field from an adjacent dot, while suppressing the generation of a perpendicular magnetization component in a trench of the cap layer when the magnetization direction is the same as that of an adjacent dot. Each embodiment can also suppress the decrease in signal intensity from a dot.

### Example 4

Bit patterned media were manufactured by changing the film thickness of the antiferromagnetic layer to 1, 2, 10, 20, 30, and 40 nm in Example 1. BPM patterning was performed by adjusting the etching time in accordance with the film thickness of the antiferromagnetic layer. The rest was performed following the same procedures as in Example 1.

When SFD analysis was performed by magnetic characteristic measurement in the same manner as in Example 1, an intrinsic SFD (σHc/Hc) of about 5% and an extrinsic SFD (a contribution to the SFD by the dipole magnetic field) of about 1% were obtained for the media in which the film thicknesses of the antiferromagnetic layers were 2, 10, 20, and 30 nm. Also, each medium was DC-magnetized by an external magnetic field, and the residual magnetization configuration was measured by MFM. As a consequence, no signal indicating the existence of a perpendicular magnetization component in a trench of the cap layer was obtained. That is, no perpendicular magnetization component existed in a trench of the cap layer. Note that the magnitude of an MFM signal output proportional to the magnetization amount from a dot was 5 mV by reflecting a large magnetization amount.

In the medium in which the film thickness of the antiferromagnetic layer was 1 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.5 mV. However, the intrinsic SFD (σHc/Hc) was 7%, and the extrinsic SFD (a contribution to the SFD by the dipole magnetic field) was 11%, i.e., both the SFD components had very large values. Furthermore, in the medium in which the film thickness of the antiferromagnetic layer was 40 nm, the intrinsic SFD (σHc/Hc) was 2%, and the extrinsic SFD (a contribution to the SFD by the dipole magnetic field) was 0%, i.e., both the SFD components had very small values. However, when MFM measurement of the residual magnetization configuration was performed after AC demagnetization using an external magnetic field, each domain region was formed by magnetically connecting a plurality of dots. That is, a cluster was formed when dot magnetization reversal occurred, and it was impossible to secure the one bit-one dot characteristic. More specifically, the medium was inadequate as a BPM medium.

Table 4 shows the results.

TABLE 4

| Antiferromagnetic | | | |
|---|---|---|---|
| layer thickness | SFD intrinsic | SFD extrinsic | |
| (nm) | (%) | (%) | MFM result |
| 1 | 7.0 | 11.0 | X |
| 2 | 5.0 | 1.0 | ◯ |
| 10 | 4.8 | 1.0 | ◯ |
| 20 | 5.1 | 1.1 | ◯ |
| 30 | 5.1 | 1.2 | ◯ |
| 40 | 2.0 | 0.0 | X |

From the above-described results, when the film thickness of the antiferromagnetic layer is 2 (inclusive) to 30 (inclusive) nm in the bit patterned medium according to the first embodiment, it is possible to reduce both the intrinsic SFD and extrinsic SFD, while suppressing the generation of a perpendicular magnetization component in a trench of the cap layer when the magnetization direction is the same as that of an adjacent dot. It is also possible to obtain the effect of presenting the decrease in signal intensity.

### Example 5

Bit patterned media were manufactured by changing the film thickness of the nonmagnetic layer formed on the antiferromagnetic layer to 0.1, 0.2, 1, 2, 5, and 7 nm in Example 1.

BPM patterning was performed by adjusting the etching time in accordance with the film thickness of the nonmagnetic layer formed on the antiferromagnetic layer. The rest was performed following the same procedures as in Example 1.

When SFD analysis was performed by magnetic characteristic measurement in the same manner as in Example 1, an intrinsic SFD (σHc/Hc) of about 5% and an extrinsic SFD (a contribution to the SFD by the dipole magnetic field) of about 1% were obtained for the media in which the film thicknesses of the nonmagnetic layers 4 formed on the antiferromagnetic layers were 0.2, 1, 2, and 5 nm. Also, each medium was DC-magnetized by an external magnetic field, and the residual magnetization configuration was measured by MFM. As a consequence, no signal indicating the existence of a perpendicular magnetization component in a trench of the cap layer was obtained. That is, no perpendicular magnetization component existed in a trench of the cap layer. Note that the magnitude of an MFM signal output proportional to the magnetization amount from a dot was 5 mV by reflecting a large magnetization amount.

In the medium in which the film thickness of the nonmagnetic layer formed on the antiferromagnetic layer was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.5 mV. However, the intrinsic SFD (σHc/Hc) was 9%, and the extrinsic SFD (a contribution to the SFD by the dipole magnetic field) was 12%, i.e., both the SFD components had very large values. When the medium surface was checked using a light emission checking device, a large number of dust particles were found, indicating that corrosion occurred from the antiferromagnetic layer and underlayers.

Furthermore, in the medium in which the film thickness of the nonmagnetic layer formed on the antiferromagnetic layer was 7 nm, the intrinsic SFD (σHc/Hc) was 10%, and the extrinsic SFD (a contribution to the SFD by the dipole magnetic field) was 2%, i.e., the intrinsic SFD value reducing effect was small.

Table 5 below shows the results.

TABLE 5

| Film thickness | | | |
|---|---|---|---|
| of nonmagnetic | SFD intrinsic | SFD extrinsic | |
| layer 1 (nm) | (%) | (%) | MFM result |
| 0.1 | 9.0 | 12.0 | ◯ |
| 0.2 | 5.0 | 1.0 | ◯ |
| 1 | 5.2 | 1.3 | ◯ |
| 2 | 4.9 | 1.0 | ◯ |
| 5 | 4.7 | 0.8 | ◯ |
| 7 | 10.0 | 2.0 | X |

From the above-described results, when the film thickness of the nonmagnetic layer 4 is 0.2 (inclusive) to 5 (inclusive) nm in the bit patterned medium according to the first embodiment, it is possible to reduce both the intrinsic SFD and extrinsic SFD, while suppressing the generation of a perpendicular magnetization component in a trench of the cap layer when the magnetization direction is the same as that of an adjacent dot. It is also possible to obtain the effect of preventing the decrease in signal intensity.

### Example 6

Bit patterned media were manufactured by changing the film thickness of the ferromagnetic layer in the antiferromagnetic layer to 0.1, 0.2, 0.5, 1, 3, and 4 nm in Example 2. BPM patterning was performed by adjusting the etching time in accordance with the film thickness of the ferromagnetic layer in the antiferromagnetic layer. The rest was performed following the same procedures as in Example 2.

When SFD analysis and MFM measurement were performed in the same manner as in Example 1, an intrinsic SFD of 5.1% and an extrinsic SFD of 1.3% were obtained for the media in which the film thicknesses of the ferromagnetic layers in the antiferromagnetic layers were 0.2, 0.5, 1, and 3 nm. Also, the result of MFM measurement after DC magnetization was the same as that in Example 1, i.e., no signal indicating the existence of a perpendicular magnetization component in a trench of the cap layer was obtained. The MFM signal output at that time was 5.6 mV.

In the medium in which the film thickness of the ferromagnetic layer in the antiferromagnetic layer was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.5 mV. However, the intrinsic SFD (σHc/Hc) was 11%, and the extrinsic SFD (a contribution to the SFD by the dipole magnetic field) was 1.3%, i.e., the intrinsic SFD component was very large. Furthermore, in the medium in which the film thickness of ferromagnetic layer in the antiferromagnetic layer was 4 nm, the intrinsic SFD (σHc/Hc) was 10%, and the extrinsic SFD (a contribution to the SFD by the dipole magnetic field) was 2%, i.e., the intrinsic SFD component was very large.

Table 6 shows the results.

TABLE 6

| Film thickness | | | |
|---|---|---|---|
| of ferromagnetic | SFD intrinsic | SFD extrinsic | |
| layer 3 (nm) | (%) | (%) | MFM result |
| 0.1 | 11.0 | 1.3 | ◯ |
| 0.2 | 5.1 | 0.9 | ◯ |
| 0.5 | 4.7 | 1.2 | ◯ |
| 1.0 | 5.1 | 1.0 | ◯ |
| 3.0 | 5.3 | 1.3 | ◯ |
| 4.0 | 10.0 | 2.0 | ◯ |

The above-described results reveal that when the film thickness of the ferromagnetic layer in the antiferromagnetic layer is 0.2 (inclusive) to 3 (inclusive) nm in the bit patterned medium according to the second embodiment, the effects of this embodiment can be obtained. That is, it is possible to reduce both the intrinsic SFD and extrinsic SFD, while suppressing the generation of a perpendicular magnetization component in a trench of the cap layer when the magnetization direction is the same as that of an adjacent dot. It is also possible to prevent the decrease in signal intensity.

### Example 7

Bit patterned media were manufactured by changing the film thickness of the nonmagnetic layer in the antiferromagnetic layer to 0.1, 0.2, 0.5, 1, 3, and 4 nm in Example 2. BPM patterning was performed by adjusting the etching time in accordance with the film thickness of the nonmagnetic layer in the antiferromagnetic layer. The magnetic recording media were manufactured by performing the rest following the same procedures as in Example 2.

When SFD analysis and MFM measurement were performed in the same manner as in Example 1, an intrinsic SFD of about 5% and an extrinsic SFD of about 1% were obtained for the media in which the film thicknesses of the nonmagnetic layers in the antiferromagnetic layers were 0.2, 0.5, and 3 nm. Also, the result of MFM measurement after DC magnetization was the same as that in Example 1, i.e., no signal indicating the existence of a perpendicular magnetization component in a trench of the cap layer was obtained. The MFM signal output at that time was 5.6 mV.

In the medium in which the film thickness of the nonmagnetic layer in the antiferromagnetic layer was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 7.0 mV. The intrinsic SFD (σHc/Hc) was 11%, and the extrinsic SFD (a contribution to the SFD by the dipole magnetic field) was 6.0%, i.e., both the SFD components were very large.

Furthermore, in the medium in which the film thickness of the nonmagnetic layer in the antiferromagnetic layer was 4 nm, the intrinsic SFD (σHc/Hc) was 10%, and the extrinsic SFD (a contribution to the SFD by the dipole magnetic field) was 2%, i.e., the intrinsic SFD value reducing effect was small.

Table 7 shows the results.

TABLE 7

| Film thickness | | | |
|---|---|---|---|
| of nonmagnetic | SFD intrinsic | SFD extrinsic | |
| layer 3 (nm) | (%) | (%) | MFM result |
| 0.1 | 11.0 | 1.3 | ◯ |
| 0.2 | 5.1 | 1.3 | ◯ |
| 0.5 | 4.6 | 1.2 | ◯ |
| 1 | 4.7 | 1.2 | ◯ |
| 3 | 4.6 | 1.1 | ◯ |
| 4 | 10.0 | 2.0 | ◯ |

The above-described results reveal that when the film thickness of the nonmagnetic layer in the antiferromagnetic layer is 0.2 (inclusive) to 3 (inclusive) nm in the bit patterned medium according to the second embodiment, the effects of this embodiment can be obtained. That is, it is possible to reduce both the intrinsic SFD and extrinsic SFD, while suppressing the generation of a perpendicular magnetization component in a trench of the cap layer when the magnetization direction is the same as that of an adjacent dot. It is also possible to prevent the decrease in signal intensity.

### Example 8

[Co (0.4 nm)/Cr (0.8 nm)/Co (0.4 nm)/CoO (x=0.1, 0.2, 0.5, 1, 3, or 4 nm)] 4 as an antiferromagnetic layer was deposited by stacking, four times, Co (0.4 nm) as a ferromagnetic layer in an antiferromagnetic layer, Cr (0.8 nm) as a nonmagnetic layer in the antiferromagnetic layer, and CoO as an oxide layer in the antiferromagnetic layer, such that the film thickness of the oxide layer was set to 0.1, 0.2, 0.5, 1, 3, or 4 nm, in the bit patterned medium according to the second embodiment. Note that BPM patterning was performed by adjusting, e.g., the etching time in accordance with the arrangement of the antiferromagnetic layer.

When SFD analysis and MFM measurement were performed in the same manner as in Example 1, an intrinsic SFD of about 4.5% and an extrinsic SFD of about 1.5% were obtained for the media in which the film thicknesses of the oxide layers in the antiferromagnetic layers were 0.2, 0.5, and 3 nm. Also, the result of MFM measurement after DC magnetization was the same as that in Example 1, i.e., no signal indicating the existence of a perpendicular magnetization component in a trench of the cap layer was obtained. The MFM signal output at that time was 5.4 mV.

In the medium in which the film thickness of the oxide layer in the antiferromagnetic layer was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 5.0 mV. The intrinsic SFD (σHc/Hc) was 5.0%, and the extrinsic SFD (a contribution to the SFD by the dipole magnetic field) was 13%, i.e., no extrinsic SFD value reducing effect was obtained.

Furthermore, in the medium in which the film thickness of the oxide layer in the antiferromagnetic layer was 4 nm, the intrinsic SFD (σHc/Hc) was 6%, and the extrinsic SFD (a contribution to the SFD by the dipole magnetic field) was 12%, i.e., the extrinsic SFD value reducing effect was small.

Table 8 shows the results.

TABLE 8

| Film thickness | | | |
|---|---|---|---|
| of oxide layer | SFD intrinsic | SFD extrinsic | |
| (nm) | (%) | (%) | MFM result |
| 0.1 | 5.0 | 13.0 | ◯ |
| 0.2 | 4.5 | 1.5 | ◯ |
| 0.5 | 4.4 | 1.3 | ◯ |
| 1 | 4.6 | 1.7 | ◯ |
| 3 | 4.9 | 1.9 | ◯ |
| 4 | 6.0 | 12.0 | ◯ |

From the above-described results, when the film thickness of the oxide layer in the antiferromagnetic layer is 0.2 (inclusive) to 3 (inclusive) nm in the bit patterned medium according to the second embodiment, it is possible to reduce both the intrinsic SFD and extrinsic SFD, while suppressing the generation of a perpendicular magnetization component in a trench of the cap layer when the magnetization direction is the same as that of an adjacent dot. It is also possible to obtain the effect of preventing the decrease in signal intensity.

### Example 9

Bit patterned media were manufactured by changing the film thickness of the nonmagnetic layer formed on the antiferromagnetic layer to 0.1, 0.2, 1, 2, 5, and 7 nm in Example 2.

BPM patterning was performed by adjusting the etching time in accordance with the film thickness of the nonmagnetic layer formed on the antiferromagnetic layer. The rest was performed following the same procedures as in Example 2, thereby manufacturing the perpendicular magnetic recording media.

When SFD analysis was performed by magnetic characteristic measurement in the same manner as in Example 1, an intrinsic SFD (σHc/Hc) of about 5% and an extrinsic SFD (a contribution to the SFD by the dipole magnetic field) of about 1% were obtained for the media in which the film thicknesses of the nonmagnetic layers formed on the antiferromagnetic layers were 0.2, 1, 2, and 5 nm. Also, no signal indicating the existence of a perpendicular magnetization component in a trench of the cap layer was obtained by MFM measurement of the residual magnetization configuration after DC magnetization. That is, no perpendicular magnetization component existed in a trench of the cap layer. Note that the magnitude of an MFM signal output proportional to the magnetization amount from a dot was 5 mV by reflecting a large magnetization amount.

In the medium in which the film thickness of the nonmagnetic layer formed on the antiferromagnetic layer was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.5 mV. However, the intrinsic SFD (σHc/Hc) was 9%, and the extrinsic SFD (a contribution to the SFD by the dipole magnetic field) was 12%, i.e., both the SFD components had very large values. When the medium surface was checked using a light emission checking device, a large number of dust particles were found, indicating that corrosion occurred from the antiferromagnetic layer and underlayers.

Furthermore, in the medium in which the film thickness of the nonmagnetic layer formed on the antiferromagnetic layer was 7 nm, the intrinsic SFD (σHc/Hc) was 10%, and the extrinsic SFD (a contribution to the SFD by the dipole magnetic field) was 2%, i.e., the intrinsic SFD value reducing effect was small.

Table 9 shows the results.

TABLE 9

| Film thickness | | | |
|---|---|---|---|
| of nonmagnetic | SFD intrinsic | SFD extrinsic | |
| layer 1 (nm) | (%) | (%) | MFM result |
| 0.1 | 9.0 | 12.0 | ◯ |
| 0.2 | 5.0 | 1.0 | ◯ |
| 1 | 4.8 | 1.1 | ◯ |
| 2 | 4.8 | 1.3 | ◯ |
| 5 | 5.1 | 1.8 | ◯ |
| 7 | 10.0 | 2.0 | ◯ |

From the above-described results, when the film thickness of the nonmagnetic layer formed on the antiferromagnetic layer is 0.2 (inclusive) to 5 (inclusive) nm in the bit patterned medium according to the second embodiment, it is possible to reduce both the intrinsic SFD and extrinsic SFD, while suppressing the generation of a perpendicular magnetization component in a trench of the cap layer when the magnetization direction is the same as that of an adjacent dot. It is also possible to obtain the effect of preventing the decrease in signal intensity.

### Example 10

Bit patterned media were manufactured by setting the number n of times of stacking of [Co (0.4 nm)/Cr (0.8 nm)] as the antiferromagnetic layer to n=1, 2, 5, and 10 in Example 2. BPM patterning was performed by adjusting the etching time in accordance with the number of times of stacking of the antiferromagnetic layer. The rest was performed following the same procedures as in Example 2.

When SFD analysis was performed by magnetic characteristic measurement in the same manner as in Example 1, an intrinsic SFD (σHc/Hc) of about 5% and an extrinsic SFD (a contribution to the SFD by the dipole magnetic field) of about 1% were obtained for the media in which the number n of times of stacking of the antiferromagnetic layer was n=2, 5, and 10. Also, no signal indicating the existence of a perpendicular magnetization component in a trench of the cap layer was obtained by MFM measurement of the residual magnetization configuration after DC magnetization. That is, no perpendicular magnetization component existed in a trench of the cap layer. Note that the magnitude of an MFM signal output proportional to the magnetization amount from a dot was 5 mV by reflecting a large magnetization amount. In the medium in which the number n of times of stacking of the antiferromagnetic layer was n=1, however, the intrinsic SFD (σHc/Hc) was 5.1%, and the extrinsic SFD (a contribution to the SFD by the dipole magnetic field) was 1.3%, i.e., both the SFD components had very small values. However, a signal indicating the existence of a perpendicular magnetization component in a trench of the cap layer was obtained by MFM measurement of the residual magnetization configuration after DC magnetization. That is, a perpendicular magnetization component existed in a trench of the cap layer. More specifically, the medium was inadequate as a BPM.

Table 10 shows the results.

TABLE 10

| Number of times | | | |
|---|---|---|---|
| of stacking of | SFD intrinsic | SFD extrinsic | |
| (Co/Cr) | (%) | (%) | MFM result |
| 1 | 5.1 | 1.3 | X |
| 2 | 4.8 | 0.8 | ◯ |
| 5 | 5.3 | 1.1 | ◯ |
| 10 | 5.7 | 1.8 | ◯ |

The above-described results reveal that when the number of times of stacking of the antiferromagnetic layer is two or more in the bit patterned medium according to the second embodiment, the effects of this embodiment can be obtained. That is, it is possible to reduce both the intrinsic SFD and extrinsic SFD, while suppressing the generation of a perpendicular magnetization component in a trench of the cap layer when the magnetization direction is the same as that of an adjacent dot. It is also possible to prevent the decrease in signal intensity.

### Example 11

Bit patterned media were manufactured by changing the film thickness of the ferromagnetic layer formed on the nonmagnetic interlayer to 0.5, 1, 2, 5, and 7 nm in Example 3. The rest was performed following the same procedures as in Example 3.

When SFD analysis was performed by magnetic characteristic measurement in the same manner as in Example 3, an intrinsic SFD (σHc/Hc) of about 5% and an extrinsic SFD (a contribution to the SFD by the dipole magnetic field) of about 1% were obtained for the media in which the film thicknesses of the ferromagnetic layers formed on the nonmagnetic interlayers were 1, 2, and 5 nm. Also, no signal indicating the existence of a perpendicular magnetization component in a trench of the cap layer was obtained by MFM measurement of the residual magnetization configuration after DC magnetization. That is, no perpendicular magnetization component existed in a trench of the cap layer. Note that the magnitude of an MFM signal output proportional to the magnetization amount from a dot was 5.4 mV by reflecting a large magnetization amount.

In the medium in which the film thickness of the ferromagnetic layer formed on the nonmagnetic interlayer was 0.5 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.8 mV. However, the intrinsic SFD (σHc/Hc) was 12%, and the extrinsic SFD (a contribution to the SFD by the dipole magnetic field) was 9%, i.e., both the SFD components had very large values.

Furthermore, in the medium in which the film thickness of ferromagnetic layer formed on the nonmagnetic interlayer was 7 nm, the intrinsic SFD (σHc/Hc) was 11%, and the extrinsic SFD (a contribution to the SFD by the dipole magnetic field) was 2.0%, i.e., the intrinsic SFD value reducing effect was small.

Table 11 shows the results.

TABLE 11

| Film thickness | | | |
|---|---|---|---|
| of ferromagnetic | SFD intrinsic | SFD extrinsic | |
| layer 4 (nm) | (%) | (%) | MFM result |
| 0.5 | 12.0 | 9.0 | ◯ |
| 1 | 5.1 | 1.5 | ◯ |
| 2 | 4.8 | 1.1 | ◯ |
| 5 | 5.0 | 1.4 | ◯ |
| 7 | 11.0 | 2.0 | ◯ |

The above-described results reveal that when the film thickness of the ferromagnetic layer formed on the nonmagnetic interlayer is 1 (inclusive) to 5 (inclusive) nm in the bit patterned medium according to the third embodiment, the effects of this embodiment can be obtained. That is, it is possible to reduce both the intrinsic SFD and extrinsic SFD, while suppressing the generation of a perpendicular magnetization component in a trench of the cap layer when the magnetization direction is the same as that of an adjacent dot. It is also possible to prevent the decrease in signal intensity.

### Example 12

Co—Ru (3 nm) magnetic films (10 to 90) were deposited by changing the Co addition amount in a Co—Ru alloy within the range of 10 to 90 at %. The films were deposited following the same procedures as in Example 1 by using the C3010 available from ANELVA, but the composition ratio was adjusted by matching the deposition rate ratio of simultaneous sputtering of a Co target and Ru target. The deposition rate ratio and composition ratio were calibrated by composition ratio analysis performed by EDX analysis after deposition. The Curie temperature of each film was measured by obtaining the dependence of saturation magnetization on the temperature by raising the sample temperature by using a VSM apparatus. The Curie temperature increased as the Co addition amount increased, and a maximum Co addition amount with which the Curie temperature was 400 K or less was 35 at %.

On the other hand, bit patterned media were manufactured by using Co—Ru (3 nm) magnetic films (10 to 90) having the above-mentioned Co composition ratios (10 to 90 at %), as the ferromagnetic layer 11 formed on the nonmagnetic interlayer in Example 3. The rest was performed following the same procedures as in Example 3.

When SFD analysis was performed by magnetic characteristic measurement in the same manner as in Example 3, an intrinsic SFD (σHc/Hc) of about 5% and an extrinsic SFD (a contribution to the SFD by the dipole magnetic field) of about 1% were obtained when the Co composition ratio of the ferromagnetic layer 11 formed on the nonmagnetic interlayer was 15 (inclusive) to 35 (inclusive) at %, i.e., when a Co composition ratio Y (15 (inclusive) to 35 (inclusive) at %) was X−20≦Y≦X (at %) with respect to a maximum Co composition ratio X (35 at %) at which the Curie temperature was 400 K or less. Also, no signal indicating the existence of a perpendicular magnetization component in a trench of the cap layer was obtained by MFM measurement of the residual magnetization configuration after DC magnetization. That is, no perpendicular magnetization component existed in a trench of the cap layer. Note that the magnitude of an MFM signal output proportional to the magnetization amount from a dot was 5.9 mV by reflecting a large magnetization amount.

When the Co composition ratio of the ferromagnetic layer 11 formed on the nonmagnetic interlayer was lower than 15 at %, however, no signal indicating the existence of a perpendicular magnetization component in a trench of the cap layer was obtained by MFM measurement of the residual magnetization configuration after DC magnetization. Also, the magnitude of the MFM signal output was as high as 4.8 mV. However, the intrinsic SFD (σHc/Hc) was about 10%, and the extrinsic SFD (a contribution to the SFD by the dipole magnetic field) was about 13%, i.e., both the SFD components had very large values.

When the Co composition ratio of the ferromagnetic layer 11 formed on the nonmagnetic interlayer was higher than 35 at %, the intrinsic SFD (σHc/Hc) was about 2.0%, and the extrinsic SFD (a contribution to the SFD by the dipole magnetic field) was about 1.0%, i.e., the SFD reducing effect was large, but a signal indicating the existence of a perpendicular magnetization component in a trench of the cap layer was obtained by MFM measurement of the residual magnetization configuration after DC magnetization. Also, when MFM measurement of the residual magnetization configuration was performed after AC demagnetization using an external magnetic field, each domain region was formed by magnetically connecting a plurality of dots. That is, a cluster was formed when dot magnetization reversal occurred, and it was impossible to secure the one bit-one dot characteristic. More specifically, the medium was inadequate as a BPM.

When the same experiments as above were conducted by using (10 to 90) Fe—Cu (3 nm) and (10 to 90) Ni—Cr (3 nm) as the ferromagnetic layer 11 formed on the nonmagnetic interlayer, the same results as those of (10 to 90) Co—Ru (3 nm) were obtained. In any medium in which the composition ratios of Fe ((10 to 90) Fe—Cu (3 nm)) and Ni ((10 to 90) Ni—Cr (3 nm)) satisfied X−20≦Y≦X (at %) with respect to the maximum composition ratio X of Fe ((10 to 90) Fe—Cu (3 nm)) to Ni ((10 to 90) Ni—Cr (3 nm)) at which the Curie temperature was 400 K or less, it was possible to obtain the effect of reducing the intrinsic SFD and the effect of reducing the extrinsic SFD caused by the dipole magnetic field from an adjacent dot, while suppressing the generation of a perpendicular magnetic component in a trench of the cap layer when the magnetization direction was the same as that of an adjacent dot. Table 12 below shows the results of (10 to 90) Co—Ru (3 nm).

TABLE 12

| Co composition | SFD intrinsic | SFD extrinsic | |
|---|---|---|---|
| ratio (at %) | (%) | (%) | MFM result |
| 5 | 10.1 | 13.0 | ◯ |
| 10 | 9.8 | 12.8 | ◯ |
| 15 | 5.1 | 1.0 | ◯ |
| 20 | 4.9 | 0.9 | ◯ |
| 25 | 4.7 | 1.2 | ◯ |
| 30 | 4.8 | 1.0 | ◯ |
| 35 | 4.8 | 1.3 | ◯ |
| 40 | 2.1 | 1.1 | X |
| 50 | 2.5 | 1.2 | X |
| 60 | 1.8 | 1.1 | X |
| 70 | 2.2 | 0.8 | X |
| 80 | 2.4 | 0.9 | X |
| 90 | 2.0 | 0.9 | X |

The above-described results reveal that the following effects can be obtained when the ferromagnetic layer 11 formed on the nonmagnetic interlayer of the bit patterned medium according to the third embodiment is made of a ferromagnetic alloy containing one or any combination of Fe, Co, and Ni and a nonmagnetic element, and, letting X be the maximum composition ratio of an element A as one of Fe, Co, and Ni at which the Curie temperature is 400 K or less in an alloy system between the elements forming the ferromagnetic alloy, the composition ratio Y of the element A in the ferromagnetic alloy is X−20≦Y≦X (at %). That is, it is possible to reduce both the intrinsic SFD and extrinsic SFD, while suppressing the generation of a perpendicular magnetization component in a trench of the cap layer when the magnetization direction is the same as that of an adjacent dot. It is also possible to prevent the decrease in signal intensity.

### Example 13

Bit patterned media were manufactured by changing the film thickness of the nonmagnetic layer 4 formed on the ferromagnetic layer 11 to 0.1, 0.2, 1, 2, 5, and 7 nm in Example 3. BPM patterning was performed by adjusting the etching time in accordance with the film thickness of the nonmagnetic layer 4 formed on the ferromagnetic layer 11. The rest was performed following the same procedures as in Example 3.

When SFD analysis was performed by magnetic characteristic measurement in the same manner as in Example 3, an intrinsic SFD (σHc/Hc) of about 5.5% and an extrinsic SFD (a contribution to the SFD by the dipole magnetic field) of about 1.5% were obtained for the media in which the film thicknesses of the nonmagnetic layers 4 formed on the ferromagnetic layers 11 were 0.2, 1, 2, and 5 nm. Also, no signal indicating the existence of a perpendicular magnetization component in a trench of the cap layer was obtained by MFM measurement of the residual magnetization configuration after DC magnetization of each medium. That is, no perpendicular magnetization component existed in a trench of the cap layer. Note that the magnitude of an MFM signal output proportional to the magnetization amount from a dot was 5.4 mV by reflecting a large magnetization amount.

In the medium in which the film thickness of the nonmagnetic layer 4 formed on the ferromagnetic layer 11 was 0.1 nm, however, no signal indicating the existence of a perpendicular magnetization component in a trench of the cap layer was obtained by MFM measurement of the residual magnetization configuration after DC magnetization. Also, the magnitude of the MFM signal output was as high as 4.8 mV. However, the intrinsic SFD (σHc/Hc) was 10%, and the extrinsic SFD (a contribution to the SFD by the dipole magnetic field) was 13%, i.e., both the SFD components had very large values. When the medium surface was checked using a light emission checking device, a large number of dust particles were found, indicating that corrosion occurred from the ferromagnetic layer formed on the nonmagnetic interlayer and from the underlayers.

Furthermore, in the medium in which the film thickness of the nonmagnetic layer 4 formed on the ferromagnetic layer 11 was 7 nm, the intrinsic SFD (σHc/Hc) was 11%, and the extrinsic SFD (a contribution to the SFD by the dipole magnetic field) was 1.9%, i.e., the intrinsic SFD value reducing effect was small.

Table 13 shows the results.

TABLE 13

| Film thickness | | | |
|---|---|---|---|
| of nonmagnetic | SFD intrinsic | SFD extrinsic | |
| layer 1 (nm) | (%) | (%) | MFM result |
| 0.1 | 10.0 | 13.0 | ◯ |
| 0.2 | 5.5 | 1.5 | ◯ |
| 1 | 5.6 | 1.4 | ◯ |
| 2 | 5.6 | 1.6 | ◯ |
| 5 | 5.8 | 1.7 | ◯ |
| 7 | 11.0 | 1.9 | ◯ |

From the above-described results, when the film thickness of the nonmagnetic layer 4 formed on the ferromagnetic layer 11 is 0.2 (inclusive) to 5 (inclusive) nm in the bit patterned medium according to the third embodiment, it is possible to reduce both the intrinsic SFD and extrinsic SFD, while suppressing the generation of a perpendicular magnetization component in a trench of the cap layer when the magnetization direction is the same as that of an adjacent dot. It is also possible to obtain the effect of preventing the decrease in signal intensity.

An example of BPM patterning will be explained below.

A medium including a 20-nm thick C mask is spin-coated with a solution prepared by dissolving a 35-nm pitch PS-PDMS diblock polymer in an anisole solvent.

Annealing is performed in an N₂ ambient at 200° C. for 13 h. Phase separation resulting from this step forms dots made of PDMS in the PS sea.

The PDMS layer on the diblock surface is etched by CF₄ RIE. Examples of the etching conditions are etching pressure: 1.0 Pa, antenna power: 100 W, bias power: 100 W, and etching time: 10 sec.

The PS region and the C mask layer below the PS region were etched by O₂ RIE, thereby forming a dot mask made of PDMS+C mask.

Examples of the etching conditions are etching pressure: 0.1 Pa, antenna power: 100 W, bias power: 50 W, and etching time: 30 sec.

Magnetic film etching is performed by Ar milling. The etching depth of this magnetic film etching is adjusted by using an end point monitor based on SIMS. Examples of the etching conditions are etching pressure: 0.01 Pa, acceleration voltage: 400 V, and etching time: 65 sec.

The C mask layer is removed by O₂ RIE. Examples of the etching conditions are etching pressure: 1.5 Pa, antenna power: 300 W, bias power: 0 W, and etching time: 40 sec.

After the mask is removed, a C protective film made of DLC is deposited within the range of a film thickness of 10 nm or less.

Each of the embodiments and examples described above can provide a bit patterned medium having a capped layer structure and capable of suppressing the generation of a perpendicular magnetization component in a trench of the cap layer when the magnetization direction is the same as that of an adjacent dot, while reducing the variation in magnetic characteristics of dots.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A perpendicular magnetic recording medium comprising:
a nonmagnetic substrate;
a nonmagnetic interlayer formed on the nonmagnetic substrate;
an antiferromagnetic layer formed on the nonmagnetic interlayer and having a thickness of 2 to 30 nm;
a first nonmagnetic underlayer formed on the antiferromagnetic layer, having a thickness of larger than 0.2 nm and equal to or smaller than 5 nm, and including a bit patterned portion and an unpatterned portion of at least 0.2 nm thick;
a first bit patterned ferromagnetic layer formed on the first nonmagnetic underlayer;
a first bit patterned nonmagnetic layer formed on the first bit patterned ferromagnetic layer; and
a second bit patterned ferromagnetic layer formed on the first bit patterned nonmagnetic layer.

2. The medium of claim 1, wherein the antiferromagnetic layer is made of at least one material selected from the group consisting of CrMn, CrRu, CrRh, CrAl, CrCu, FeMn, MnCo, MnPd, MnPt, MnNi, MnIr, and NiO.

3. The medium of claim 1, wherein the antiferromagnetic layer includes:
a multilayered structure formed by alternately stacking, not less than twice;
a ferromagnetic layer having a thickness of 0.2 to 3 nm; and
a nonmagnetic layer having a thickness of 0.2 to 3 nm.

4. The medium of claim 3, wherein a combination of the ferromagnetic layer/the nonmagnetic layer forming the antiferromagnetic layer is selected from the group consisting of Fe/Cr, Fe/Cu, Fe/Ru, Fe/Au, Fe/Ag, Co/Cr, Co/Cu, Co/Ru, Co/Au, and Co/Ag.

5. The medium of claim 1, wherein the antiferromagnetic layer includes a multilayered structure formed by sequentially stacking, not less than twice, a ferromagnetic layer having a thickness of 0.2 to 3 nm, a nonmagnetic layer having a thickness of 0.2 to 3 nm, and an oxide layer having a thickness of 0.2 to 3 nm.

6. The medium of claim 5, wherein a combination of the ferromagnetic layer/the nonmagnetic layer/the ferromagnetic layer/the oxide layer forming the antiferromagnetic layer is selected from the group consisting of Fe/Cr/Fe/Fe oxide, Fe/Cr/Fe/SiO₂, Fe/Cu/Fe/Fe oxide, Fe/Cu/Fe/SiO₂, Fe/Ru/Fe/Fe oxide, Fe/Ru/Fe/SiO₂, Fe/Au/Fe/Fe oxide, Fe/Au/Fe/SiO₂, Fe/Ag/Fe/Fe oxide, Fe/Ag/Fe/SiO₂, Co/Cr/Co/Co oxide, Co/Cr/Co/SiO₂, Co/Cu/Co/Co oxide, Co/Cu/Co/SiO₂, Co/Ru/Co/Co oxide, Co/Ru/Co/SiO₂, Co/Au/Co/Co oxide, Co/Au/Co/SiO₂, Co/Ag/Co/Co oxide, and Co/Ag/Co/SiO₂.

7. A perpendicular magnetic recording medium comprising:
a nonmagnetic substrate;
a nonmagnetic interlayer formed on the nonmagnetic substrate;
a ferromagnetic layer formed on the nonmagnetic interlayer, having a thickness of 1 to 5 nm, and made of at least one metal selected from the group consisting of iron, cobalt, and nickel and a ferromagnetic alloy containing the metal and a nonmagnetic metal element, in which letting X be a maximum composition ratio of an element A as one of iron, cobalt, and nickel at which a Curie temperature is not more than 400 K in an alloy system between the elements forming the ferromagnetic alloy, a composition ratio Y of the element A in the ferromagnetic alloy is X−20≦Y≦X (at %);
a first nonmagnetic underlayer formed on the ferromagnetic layer and having a thickness of 0.2 to 5 nm;
a first bit patterned ferromagnetic layer formed on the first nonmagnetic underlayer;
a first bit patterned nonmagnetic layer formed on the first bit patterned ferromagnetic layer; and
a second bit patterned ferromagnetic layer formed on the first bit patterned nonmagnetic layer.

8. The medium of claim 7, wherein the ferromagnetic layer is selected from the group consisting of CoCr, CoCrPt, CoPt, CoPd, CoRu, CoCu, FeCr, FeCrPt, FePt, FePd, FeRu, FeCu, NiCr, NiCrPt, NiPt, NiPd, NiRu, and NiCu.

9. A magnetic recording/reproduction apparatus comprising:
a perpendicular magnetic recording medium comprising a nonmagnetic substrate, a nonmagnetic interlayer formed on the nonmagnetic substrate, an antiferromagnetic layer formed on the nonmagnetic interlayer and having a thickness of 2 to 30 nm, a first nonmagnetic underlayer formed on the antiferromagnetic layer, having a thickness of larger than 0.2 and equal to or smaller than 5 nm, and including a bit patterned portion and an unpatterned portion of at least 0.2 nm thick, a first bit patterned ferromagnetic layer formed on the first nonmagnetic underlayer, a first bit patterned nonmagnetic layer formed on the first bit patterned ferromagnetic layer, and a second bit patterned ferromagnetic layer formed on the first bit patterned nonmagnetic layer; and
a recording/reproduction head.

10. The apparatus of claim 9, wherein the antiferromagnetic layer is made of at least one material selected from the group consisting of CrMn, CrRu, CrRh, CrAl, CrCu, FeMn, MnCo, MnPd, MnPt, MnNi, MnIr, and NiO.

11. The apparatus of claim 9, wherein the antiferromagnetic layer includes a multilayered structure formed by alternately stacking, not less than twice, a ferromagnetic layer having a thickness of 0.2 to 3 nm, and a nonmagnetic layer having a thickness of 0.2 to 3 nm.

12. The apparatus of claim 11, wherein a combination of the ferromagnetic layer/the nonmagnetic layer forming the antiferromagnetic layer is selected from the group consisting of Fe/Cr, Fe/Cu, Fe/Ru, Fe/Au, Fe/Ag, Co/Cr, Co/Cu, Co/Ru, Co/Au, and Co/Ag.

13. The apparatus of claim 9, wherein the antiferromagnetic layer includes a multilayered structure formed by sequentially stacking, not less than twice, a ferromagnetic layer having a thickness of 0.2 to 3 nm, a nonmagnetic layer having a thickness of 0.2 to 3 nm, and an oxide layer having a thickness of 0.2 to 3 nm.

14. The apparatus of claim 13, wherein a combination of the ferromagnetic layer/the nonmagnetic layer/the ferromagnetic layer/the oxide layer forming the antiferromagnetic layer is selected from the group consisting of Fe/Cr/Fe/Fe oxide, Fe/Cr/Fe/SiO₂, Fe/Cu/Fe/Fe oxide, Fe/Cu/Fe/SiO₂, Fe/Ru/Fe/Fe oxide, Fe/Ru/Fe/SiO₂, Fe/Au/Fe/Fe oxide, Fe/Au/Fe/SiO₂, Fe/Ag/Fe/Fe oxide, Fe/Ag/Fe/SiO₂, Co/Cr/Co/Co oxide, Co/Cr/Co/SiO₂, Co/Cu/Co/Co oxide, Co/Cu/Co/SiO₂, Co/Ru/Co/Co oxide, Co/Ru/Co/SiO₂, Co/Au/Co/Co oxide, Co/Au/Co/SiO₂, Co/Ag/Co/Co oxide, and Co/Ag/Co/SiO₂.
